(19) United States
(12) Patent Application Publication
(10) Pub. No.: US 2006/0207413 A1
(43) Pub. Date: Sep. 21, 2006

(54) Optical detection cell and sensor using one such cell

(76) Inventor: Jean-Claude Tisserand, Custines (FR)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 10/555,299

(22) PCT Filed: Apr. 30, 2004
(86) PCT No.: PCT/FR04/01051

§ 371 Date: Nov. 2, 2005

(30) Foreign Application Priority Data
May 2, 2003 (FR) 03/05387

(51) Int. Cl. G10H 3/06

(52) U.S. Cl. 84/724

(57) ABSTRACT

The invention concerns a cell for detecting the mechanical vibrations of an object. It includes a first phototransmitter 22 for emitting a light beam on one side of the said object, and two photoreceivers 24, 25. Each photoreceiver 24, 25 has a detection surface arranged in such a way as to receive the light beam modulated by the shadow cast by the object. The phototransmitter 22 and the photoreceivers 24, 25 are distributed on an internal cross-section of a hollow tube forming the structure of the cell, the object being placed close to the centre of the said cross-section. The invention also concerns a vibration sensor comprising several cells according to one of the above claims, mechanically associated with each other to enable the simultaneous detection of the vibrations of several objects, and a command module for controlling the operation of each cell individually. Applications: sensors for stringed musical instruments, sensor for measuring the tension of a cable, etc.

The present invention concerns an optical cell for detecting the mechanical vibrations of an object, and a vibration sensor using such a detection cell. The invention is of particular interest for making a microphone enabling the amplification of stringed musical instruments; more generally, it can be used for detecting the vibrations of a wire and/or for measuring the tension of wire.

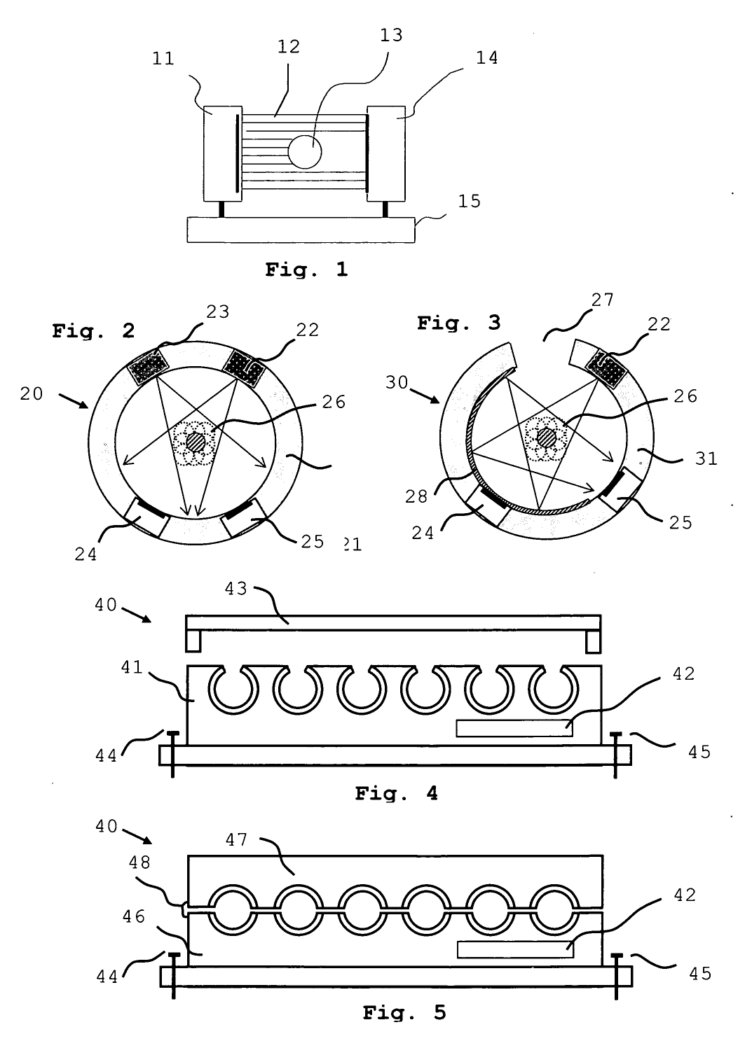

An optical detection cell is known in particular by means of document D1 (U.S. Pat. No. 4,563,931) for detecting the vibrations of a musical instrument's string. The general principle of this cell is outlined in FIG. 1. A phototransmitter 1 emits a light beam 2 which illuminates the string 3. A photoreceiver 4 receives the light beam emitted by the phototransmitter 1 and the shadow cast by the string 3 which directly modulates the light beam according to the vibratory oscillation of the string 3. The photoreceiver 4 produces a modulated electrical signal representative of the frequency, timbre and amplitude of the vibrations of the string 2. An electronic module 5 commands the transmitter 1 and the receiver 4, and processes the electrical signal received from the photoreceiver 4.

However, the cell of D1 is not very efficient. Indeed, in practice, it only makes it possible to detect the string's vibrations in a plane perpendicular to the axis formed by the transmitter and the receiver. It does not make it possible to take into account the string's other vibration planes.

In order to compensate for this drawback, Curtis et al. proposed in document D2 (U.S. Pat. No. 5,237,126) a sensor that uses a phototransmitter and two photoreceivers, each positioned on the sides of an isosceles triangle-shaped structure. The signals delivered by the two receivers are subtracted to obtain a signal representative of the frequency, timbre and amplitude of the string's vibrations. The sensor thus makes it possible to take into account all of the string's vibration planes and thus enables a higher-quality electronic transcription to be obtained.

However, the triangular structure allows large movements in a single direction (the height of the triangle), which limits the effects (particular and generally high-amplitude movements imposed on a string to obtain a particular sound effect) that it is possible to detect. Furthermore, despite the utilisation of a differential noise reduction by subtraction of the signals received from the two photoreceivers, the sensors obtained remain quite sensitive to their luminous environment and their quality is degraded when they are used in an environment with a great deal of light pollution such as concert halls.

One of the main objectives of the invention is to provide an optical detection cell making it possible to detect high-amplitude movements of an object whatever the direction of those movements. A secondary objective of the invention is to improve the accuracy and quality of the analog signal restored by the detection cell.

The main objective of the invention is achieved by means of a cell that detects an object's vibrations comprised of a first phototransmitter which emits a light beam on one side of the said object, a first photoreceiver and a second photoreceiver. Each photoreceiver has a detection surface that is arranged in such a way as to receive the light beams modulated by the shadow cast by the object. The phototransmitter, the first photoreceiver and the second photoreceiver are distributed over an internal cross-section of a hollow tube forming the structure of the cell, the object being placed close to the centre of the said cross-section.

The main components of the cell, in particular the light transmitters and the photoreceivers, are available industrially in a miniaturised version. This makes it possible to produce lightweight cells with very small dimensions. The cell can thus be easily integrated in the vicinity of the object whose vibrations are being detected.

The light beam received by each photoreceiver is transformed into an electrical signal—representative of the object's frequency, timbre and amplitude—that is capable of being amplified if necessary by conventional means. Furthermore, the structure of the cell being tubular in shape, with a circular cross-section, the object can have large movements in every direction in the cell's cross-section and not just in one privileged direction.

According to a variant, the cell also includes a second phototransmitter. In this case, the first photoreceiver is arranged in such a way as to receive a light beam transmitted by the first phototransmitter and the second photoreceiver is arranged in such a way as to receive a light beam from the second phototransmitter. According to another variant, the inner surface of the tube includes a reflective zone, so that part of the beam emitted by the first phototransmitter is received on the reflective zone and reflected in the direction of the second photoreceiver.

The two photoreceivers can be situated on orthogonal axes of the structure's cross-section, this makes it possible to detect the object's two vibration planes independently from each other. One of the phototransmitters and one of the photoreceivers can be situated on a diameter of the cross-section, on either side of the object. Lastly, the tube may include a longitudinal opening, facilitating the insertion of the object in the cell.

It is possible to improve the quality of the output signal by filtering any stray light signals by means of a synchronous modulation/demodulation of the light signals transmitted/received. To achieve this, the phototransmitter(s) emit(s) a light beam in the form of a pulse train and the photoreceiver(s) detect(s) the pulse train in synchronism.

The invention also concerns a vibration sensor, including a cell such as described above, and a command module for controlling the operation of the cell. In one production mode, the sensor includes several cells mechanically associated with each other to enable the simultaneous detection of the vibrations of several objects, and a command module for controlling the operation of each cell individually. In a preferred application, the objects are the strings of a musical instrument, each string being placed close to the centre of a detection cell. The sensor can be completed by an appropriate amplifier and/or by an electronic signal processing module capable of transforming the signals produced by each cell in one or more signals conform to the MIDI communication protocol.

According to the invention, the sensor can process each of the strings of the instrument under consideration independently by using one light transmitter per string, and one or more photoreceivers per string. This gives it polyphonic or stereophonic properties depending on the choice of photoreceiver coupling and enables specific applications a few examples of which we will see hereinafter.

The invention will be better understood and other characteristics and advantages will appear on reading the description given below of an example of implementation of a detection cell and of a sensor according to the invention. The description should be read in relation with the drawings in appendix in which:

FIG. 1, already described, is a schematic diagram of a known optical detection cell,

FIGS. 2 and 3 are cross-section views of particular types of setup of a detection cell according to the invention,

FIGS. 4 and 5 show sensors with several detection cells suitable for being attached to a stringed musical instrument,

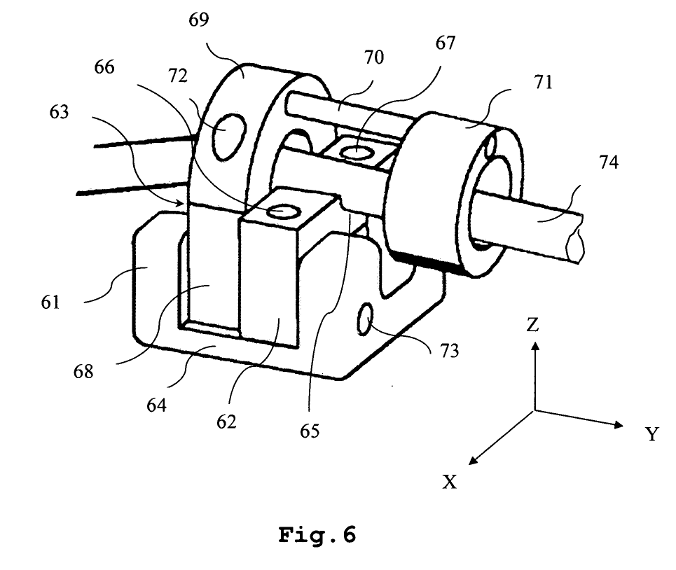

FIG. 6 shows a sensor with a single detection cell suitable for being attached to a stringed musical instrument.

A cell according to the invention has a hollow tubular structure that is open at both ends. It is preferably made of an opaque or reflective material, so as to prevent stray light from entering the tube, and preferably of a lightweight material. For example, a plastic material could be used that is capable of filtering out the daylight, a resin, a composite material or a light alloy. For example, for a cell used to detect the vibrations of a musical instrument's string, the cell's dimensions are approximately: external diameter: 7.5 mm, internal diameter: 5.5 mm, height: 6 mm. The string whose vibrations we want to detect is positioned approximately in the centre of the structure and passes through the tube from one end to the other.

In the example in FIG. 2, the tubular structure 21 of the cell 20 is closed and the string is inserted in the structure through one of its ends. In the example in FIG. 3, the tubular structure 31 has an opening 27 over the whole height of the tube to facilitate the insertion of the string in the cell.

A cell according to the invention also includes at least one phototransmitter 22 and at least two photoreceivers 24, 25 positioned on the inner circumference of a cross-section of the tubular structure 21. Lastly, the cell includes an electronic module (not shown in FIGS. 2 and 3) to control the transmitter(s) and the receiver(s), and process the electrical signals received from the photoreceivers 24, 25.

In the example in FIG. 2, the cell includes two phototransmitters 22, 23 and two photoreceivers 24, 25. One transmitter and one photoreceiver are associated and are positioned on the ends of a diameter of a cross-section of the tubular structure, on either side of the string. In practice, it suffices that the receivers should be placed in the light beam emitted by one or other of the phototransmitters. The relative position of the photoreceivers with respect to one another and with respect to the phototransmitters, as well as the opening angle of each phototransmitter are chosen in such a way that the light beam emitted by one phototransmitter is received by a single photoreceiver and in such a way that each beam illuminates the whole deflection surface 26 of the string.

In the example in FIG. 3, the cell includes a single phototransmitter 22, and the internal surface of the hollow tube 31 is reflective at least in one zone 28. The reflective surface, on the internal surface of the tube, is for example obtained by applying a reflective paint, by depositing a reflective dielectric coating or by bonding a film of reflective material (silver plating, aluminium, etc.). The surface 28 may cover all of the internal surface of the tube or only an appropriate zone. Of course, if the tube is made of a reflective material, its internal surface will not require any additional treatment. The reflective surface receives the light beam emitted by the transmitter 22 and reflects this beam towards the receiver 25. The reflective surface 28 thus replaces the second phototransmitter. The relative position of the photoreceivers, of the reflective zone 28 and of the opening in the transmitter 22 are chosen in such a way that the receiver 24 receives the beam transmitted by the transmitter 22, in such a way that the receiver 25 receives the beam reflected by the surface 28 and in such a way that the transmitted beam and the reflected beam illuminate the whole deflection surface 26 of the string.

The two photoreceivers 24, 25 of the cell 30 are placed on perpendicular diameters. We thus detect distinctly and independently the fundamental and the harmonics of the string's two vibration planes, independently from each other, which then facilitates the processing of the measured signals. As for the two photoreceivers 24, 25 of the cell 20 they are closer to each other and form an angle of less than 90°. The signals detected by the two photoreceivers each contain information relative to the string's movements in both vibration planes.

It is also possible to make a detection cell comprising more than two receivers, for example three or four, distributed around the internal cross-section of the tube. We thus have a redundant item of information on the fundamental and the harmonics of each vibration plane, which then makes it possible to carry out a more precise digital processing of the signal.

Different types of photoreceivers (or photoelectric sensors) presenting photoconducting properties can be used for the reception of the modulated light signal. For example, photoresistors, photodiodes, phototransistors, photodarlingtons, CCD sampling sensors, etc. can be used.

Also, different types of phototransmitters may be used to emit the light. We preferably use optoelectronic components transmitting in the visible or invisible spectrum (infrared for example), and suited to being commanded individually in voltage and/or current to vary the intensity of the light beam being emitted. For, example it is possible to use laser diodes or miniature LEDs, preferably operating at low voltage (approximately 2.3 volts) and with a high light intensity. It is also possible advantageously to use OLEDs (for Organic Light Emitter Device). The advantage of these diodes is that they can be made in the form of a thin and flexible film, particularly well-suited to being fixed to a non-plane tubular structure, that can easily have opaque covered zones (by silkscreen printing for example) making it possible to obtain a personalised and localised distribution of the light. The beam(s) emitted may be collimated or divergent.

To improve detection, and protect against any stray light signals, detection is carried out by synchronous modulation/demodulation. To achieve this, the phototransmitters generate a light beam in the form of high-frequency pulse trains (for example of the order of 44 KHz), and the photoreceivers detect these pulses simultaneously. The frequency of the pulses is chosen sufficiently high with respect to the frequency of the surrounding signals that could interfere with the detection cell (signals emitted by the lighting, flashes, etc., which in general have relatively low frequencies).

The cell's electronic module ensures the control of each phototransmitter and of each photoreceiver. For example, it sets the frequency of the beam pulses emitted by the phototransmitter. The electronic module also sets the intensity of the light emitted by each transmitter (for example by varying the electrical current powering the transmitter); this makes it possible to adjust the output level of the analog signal produced by the cell and/or to privilege the string's movements in one or other of the cell's vibration planes. Lastly, the electronic module processes the analog signals produced by the photoreceivers to extract the fundamental and the harmonics in the string's two vibration planes and produces an analog signal representative of the frequency, timbre and amplitude of the string's movements.

FIG. 6 shows a sensor 60 suitable for detecting the vibrations of a musical instrument's string. A shoe 61, more or less U-shaped, serves as support for a saddle 62 and a counter-saddle 63, which can thus slide between the branches of the shoe along the x axis. The base 64 of the shoe 61 is fixed to the musical instrument's soundboard.

The saddle 62 is more or less a parallelepiped, it replaces the saddle that usually supports the string of a musical instrument. The saddle 62 has a notch 65 on the top for housing and holding the string 74 in position and two holes 66, 67 designed to receive two set screws (not shown) which are used to adjust the position of the saddle (and therefore of the string that it holds) along a vertical z axis perpendicular to the base 64. The counter-saddle 63 and the saddle 62 can slide with respect to each other along the x axis, and there is a locking device (a screw, for example, not shown) to attach the saddle and counter-saddle together, so that it is possible simultaneously to adjust the height of the saddle 62 and that of the counter-saddle 63. These is a housing 73 for a screw (not shown) making it possible to lock the position of the saddle in the shoe after adjustment.

The counter-saddle includes two more or less U-shaped blocks 68, 69 and a pin 70. One end of the pin is attached to the block 69, and the detection cell 71 is attached to the other end of the pin. The counter-saddle thus serves to position and hold in position the detection cell with respect to the string 74, the latter in turn being positioned and held by the saddle. The blocks 68, 69 are designed to be assembled so as to form an empty space in the middle to provide a passage for the string (without touching it) to be detected. The block 68 rests on the base 64, and two set screws (only one screw 72 is shown) make it possible to adjust the position (height) along the z axis of the block 69 (and therefore of the cell 71 which is integral with it) with respect to the block 68 and attach the two blocks together. The cell 71 slides along the pin 70 in the y direction, which makes it possible to adjust the distance between the cell and the bridge, according to the expected amplitude of the string's vibrations. The cell 71 is also installed pivoting around the pin 70, so as to position the string 74 approximately in the centre of the cell 71. Means of locking (not shown) are also provided for attaching the cell 71 to the pin 70 after adjustment.

For example, the shoe, saddle and counter-saddle can be made of resin or of a plastic material. The pin 71 can be made of metal, for example of steel or of brass.

The sensor in FIG. 6 is particularly interesting for the large number of settings that it allows, making it possible to:
optimise the position of the cell 71 with respect to the string in order to obtain optimum detection of the string's vibrations; this is done for example by the sensor's manufacturer.
optimise the position of the string with respect to the base of the shoe and of the musical instrument's soundboard; this adjustment can be carried out by the musician and does not require any knowledge of how the sensor functions: since the saddle follows the movements of the bridge, the position of the cell with respect to the string is maintained if the height of the bridge is modified.

FIG. 4 shows a sensor 40 suited to wiring a six-stringed instrument for sound. This sensor includes a confinement box 41 in which are placed six detection cells according to the invention. On its sides, this box of course has openings allowing the instrument's strings to enter and exit. The box is closed with a cover 43. In a variant (FIG. 5), the box is essentially made up of two blocks 46, 47 attached to each other on one side by a hinge 48. Half-cylinders are hollowed out in each block 46, 47 suitable for housing the bodies of the detection cells when the cells are assembled together. The block 47 can be raised to install or change the strings.

Two set screws 44, 45 make it possible to attach the box to the instrument 46 and adjust the height and angle of the box, so that the strings are correctly positioned in the centre of the light beam emitted by each cell's transmitters.

The box should preferably be attached as close as possible to a point where the strings are attached to the instrument. According to a variant, the box is attached to the body of the instrument, in the vicinity of a pre-existing bridge on the instrument, the said bridge also serving to position and maintain all of the strings. According to another variant, the sensor and the bridge are associated in the same box, and means are provided for adjusting the position of the detection cells with respect to the bridge. So, if the position of the bridge is modified, the position of the sensor is modified at the same time. In yet another variant, there is one bridge and one detection cell per string; this makes it possible to adjust independently for each string the position of the string with respect to the instrument and the position of the cell with respect to the bridge.

Each cell's electronic modules are grouped together in a single electronic module 42. The signals generated by each cell are either exploited separately to be used with the MIDI communication protocol, or combined to produce a single signal. It will also be possible to amplify the signals generated by each cell independently from each other (a pre-amplifier with gain adjustable by means of an electronic potentiometer is provided on the output from each cell), or to amplify the signal obtained after combining the signals produced by each cell.

The DC power supply to the detection cells (receivers and transmitters) is ensured by an electrical battery or by a rechargeable battery (not shown) delivering a voltage of approximately 7 volts. A single electrical lead could be provided to transmit the audio signals to the exterior and provide the electrical power required for recharging the battery.

The electronic module manages each phototransmitter/photoreceiver pair of each cell independently from each other, which makes it possible to obtain different sound effects.

For example, it is possible to power the phototransmitters of different cells with currents of different intensities. We can thus adjust the light intensity of each transmitter, and therefore the level (sound volume) of the output signal (produced by a cell) associated with each string and we balance, according to an appropriate choice, the sensor's overall sound response after amplification.

The electronic module can also control an equaliser, placed at the output from each detection cell, and controlled by an electronic potentiometer and thus adjust the tone of each string separately. In the case where the signals from each cell are combined to form a single signal, it is also possible to provide a single equaliser to adjust only the tone of the signal after combination.

It is also possible to vary sequentially (from one string to the next) the light intensity in each cell according to a sinusoidal function modulation. We thus generate, at the level of the output sound signal, a so-called “phasing” phase rotation.

In order to generate an “arpegiator” effect, you just have to trigger successively, and according to a programmable sequence, the operation of each transmitter. Applied to a guitar for example, the fact of playing the six strings simultaneously from the sixth to the first will, while the strings are resonating, produce a series of distinct notes in the order that has been defined, and separated from each other by an interval of variable time—which corresponds to an arpeggio—rather than a sound or chord produced by the set of notes produced.

The electronic module is also advantageously completed by:
a means (a graphic interface for example) enabling the user to configure, in an ergonomic way, the electronic module (microcontroller, electronic potentiometers, battery charging level, for example), define a desired setting, call up a previously memorised setting, etc.;
a means for transmitting the signals detected and possibly pre-amplified, and the digital data to the external devices; it will thus be possible to provide an output port for the digital data, etc.

It should be noted that the detection cell of the invention can have other applications than serving as sensor for stringed musical instruments. The cell could be used for example to obtain the appropriate tension setting for the strings of a sports racquet (tennis, badminton, etc.), or to measure the tension of a metallic cable supporting any structure and report any rupture. More generally, the cell can be used in any application where it is necessary to detect the movements of an object such as a wire or a string, or to measure the tension of a wire or string.

1. Cell for detecting the mechanical vibrations of an object, the cell comprising:
a first phototransmitter to emit a light beam on one side of the object; and
a first photoreceiver and a second photoreceiver,
wherein each photoreceiver has a detection surface arranged to receive the light beam modulated by the shadow cast by the object, the phototransmitter, the first photoreceiver and the second photoreceiver being distributed over an internal cross-section of a hollow tube with a cylindrical cross-section forming a structure for the cell, the object being placed close to the center of the cross-section.

2. Cell according to claim 1, also including a second phototransmitter, the first photoreceiver being arranged to receive a light beam emitted by the first phototransmitter and the second photoreceiver having a surface arranged to receive a beam from the second phototransmitter.

3. Cell according to claim 1, in which the internal surface of the tube includes a reflective zone, so that part of the beam emitted by the first phototransmitter is received on the reflective zone and reflected towards the second photoreceiver.

4. Cell according to claim 1, in which the two photoreceivers are situated on the orthogonal axes of the cross-section of the structure.

5. Cell according to claim 1, in which one of the phototransmitters and one of the photoreceivers are situated on a diameter of the cross-section, on either side of the object.

6. Cell according to claim 1, in which the tube has a longitudinal opening.

7. Cell according to claim 1, in which the phototransmitter(s) emit a pulse train and in which the photoreceiver(s) detect the pulse train in synchronism.

8. Cell according to claim 7, in which the phototransmitter(s) are LEDs of the organic type.

9. Cell according to claim 8, in which the phototransmitter(s) take the mechanical form of a fine flexible film.

10. Vibration sensor comprising
a cell according to claim 1; and
a command module for controlling the operation of the cell.

11. Sensor according to claim 10, adapted to detect the vibrations of a musical instrument's string, an axis of the cylindrical cell being positioned in the vicinity of the string.

12. Sensor according to claim 11, also comprising a bridge that can be adjusted to position and maintain the string in a chosen position in a plane perpendicular to the string, and means for adjusting the position of the detection cell with respect to the bridge.

13. Sensor according to claim 10, comprising several of the detection cells, mechanically associated with each other to enable the simultaneous detection of the vibrations of several strings of a musical instrument, each string being placed according to the direction and in the vicinity of the axis of a detection cell.

14. Sensor according to claim 13, comprising as many adjustable bridges as there are strings, a detection cell and associated means of adjustment being provided to adjust, independently for each string, the position of the detection cell with respect to the associated bridge.

15. Sensor according to claim 13, comprising a box of an appropriate shape to form hollow tubes side by side each one of which constitutes the body of a detection cell.
